(19) United States
(12) Patent Application Publication
(10) Pub. No.: US 2016/0329586 A1
(43) Pub. Date: Nov. 10, 2016

(54) FUEL CELL STACK ASSEMBLY AND METHOD OF ASSEMBLY

(71) Applicant: INTELLIGENT ENERGY LIMITED, Loughborough (GB)

(72) Inventors: Daniel Ninan, Loughborough (GB); Christopher Kirk, Loughborough (GB); Paul Adcock, Loughborough (GB); Hossein Ostadi, Loughborough (GB)

(73) Assignee: Intelligent Energy Limited, Loughborough (GB)

(21) Appl. No.: 15/109,081

(22) PCT Filed: Dec. 17, 2014
(86) PCT No.: PCT/GB2014/053741

§ 371 Date: Jun. 29, 2016

(30) Foreign Application Priority Data
Dec. 31, 2013 (GB) 1323166.7

(51) Int. Cl. H01M 8/1004; H01M 8/1069; H01M 8/0239; H01M 4/86; H01M 4/88; H01M 8/1067; H01M 8/0234

(52) U.S. Cl. CPC H01M 8/1004; H01M 8/1067; H01M 8/1069; H01M 8/0234; H01M 4/861; H01M 4/8636; H01M 4/881; H01M 4/8832; H01M 4/8828; H01M 8/0239; H01M 2008/1095

(57) ABSTRACT

A method of manufacturing a membrane electrode assembly for a fuel cell comprising a proton exchange membrane and a catalyst layer including a catalyst, the method comprising; forming a gas diffusion layer comprising graphene.

This invention relates to a membrane electrode assembly and a fuel cell assembly. It also relates to a method of manufacturing a fuel cell assembly.

Conventional electrochemical fuel cells convert fuel and oxidant, generally both in the form of gaseous streams, into electrical energy and a reaction product. A common type of electrochemical fuel cell for reacting hydrogen and oxygen comprises a polymeric ion (proton) transfer membrane having electrodes either side comprising an anode and a cathode. The fuel and oxidant is passed over respective sides of the membrane. Protons (that is, hydrogen ions) are conducted through the membrane, balanced by electrons conducted through a circuit connecting the anode and cathode electrodes of the fuel cell. To increase the available voltage, a plurality of fuel cells may be arranged in a stack comprising a number of such membranes arranged with separate anode and cathode fluid flow paths.

The electrodes typically have at least one of a plurality of layers formed on the membrane such as a catalyst layer (CL), a microporous layer (MPL) and a gas diffusion layer (GDL). The catalyst layer includes a catalyst to catalyse the reaction required at the electrode of the particular fuel cell. In a hydrogen-oxygen proton exchange membrane (PEM) fuel cell, for example, the catalyst at the anode is selected to oxidize the hydrogen fuel into a hydrogen ion (proton) and a negatively charged electron.

The microporous layer may comprise a conductive, hydrophobic layer to provide electrical contact between the catalyst layer and subsequent layers and also assist with liquid or water management at the electrode. The MPL provides for transport of product water and reactant gases to and from the CL, as well as providing pathways for electron conduction.

The gas diffusion layer typically comprises a porous layer having larger pores than the MPL. The function of the GDL is to receive gaseous fuel or oxidant flowing in gas distribution channels and provide a porous surface to receive the gas such that it diffuses evenly into the electrode layers for reaction.

The structure and materials used in the layers and how the layers are manufactured is important for efficient operation and construction of the fuel cell.

According to a first aspect of the invention we provide a method of manufacturing a membrane electrode assembly for a fuel cell comprising a proton exchange membrane and a catalyst layer including a catalyst, the method comprising;
forming a gas diffusion layer comprising graphene.

This is advantageous as providing graphene in the gas diffusion layer has been found to provide for a highly conductive and hydrophobic gas diffusion layer. The gas diffusion layer can be thin and the total resistance therethrough can be low.

The step of forming may comprise forming different areas of the gas diffusion layer with different porosities. This is advantageous as different areas through the thickness of the layer can have different porosities. Also, the porosity may vary as a function of position transverse to the plane of the layer. Thus, the porosity can be varied such that it is suitable for the part of the fuel cell assembly the layer is located.

The gas diffusion layer may include a microporous layer, the microporous layer forming an interface between the catalyst layer and the gas diffusion layer. The provision of a microporous layer can assist with water and gas transport in the membrane electrode assembly. The microporous layer may comprise carbon black or graphite having pores therein and hydrophobic components, such as PTFE. The pore size may be between 100 and 500 nm. The hydrophobicity of the MPL assists it in preventing flooding. The pores of the GDL are typically between 10 and 30 μm diameter. The GDL may be more porous and/or less hydrophobic than the MPL and/or comprise a fibrous carbon based material.

Only the microporous layer part of the gas diffusion layer may comprise graphene.

The gas diffusion layer and/or microporous layer may be formed by printing. This is an advantageous way of forming the layer to provide precise control of porosity, for example, and other structural properties. The printing technique may be inkjet printing, 3D printing or additive printing among others.

The gas diffusion layer and/or microporous layer may be formed from at least two different feedstocks:
a first feedstock comprising particles having a first property; and
a second feedstock comprising particles having a second property different to the first property; and the method comprises
forming different areas of the gas diffusion layer from the different feedstocks.

The use of different feedstocks is advantageous to provide control in forming the layers.

The first property may comprise a first particle size distribution and the second property may comprise a second particle size distribution different to the first particle size distribution. Using feedstocks of different particle size distributions may provide a convenient way of providing different areas of the layers with different porosities or other structural properties.

Optionally, the first property comprises the first feedstock having a hydrophobic agent and the second property comprises the second feedstock having a hydrophilic agent. This is advantageous as the wetting properties of different parts of the layers can be controlled. The hydrophilic agent and hydrophobic agent may be provided separate to the first and second feedstocks. Thus, the wetting agents may be added to the feedstocks as required or may be added during the forming step (i.e. to whatever feedstock is being output at the time). A combination of wetting characteristic and particle size may be provided as the properties of first and second feedstocks.

The gas diffusion layer may comprise a plurality of gas diffusion sub-layers, each sub layer having a different property. The microporous layer may comprise a plurality of microporous sub-layers, each sub layer having a different property. Different areas of each of the gas diffusion sub-layers may have different porosities. Different areas of each of the microporous sub-layers may have different porosities. This is advantageous as the structure of the layer can be controlled in three dimensions.

The gas diffusion sub-layers and/or microporous sub-layers may be formed from at least two different feedstocks: a first feedstock comprising particles with a first property; and a second feedstock comprising particles with a second property; the first property being different to the second property.

The first property may comprise a first particle size distribution and/or the first feedstock having a hydrophobic agent; and the second property may comprise a second particle size distribution and/or the second feedstock having a hydrophilic agent. Thus, the sub-layers as well as the layer as a whole may utilise the flexibility of using two or more feedstocks.

The method may include the step of forming the catalyst layer by printing. The catalyst layer may comprise graphene.

According to a further aspect, we provide a membrane electrode assembly for a fuel cell comprising: a proton exchange membrane; a catalyst layer adjacent the proton exchange membrane; and a gas diffusion layer comprising graphene.

The gas diffusion layer may include a microporous layer, the microporous layer forming an interface between the catalyst layer and the gas diffusion layer. Optionally, only the microporous layer of the gas diffusion layer comprises graphene.

The gas diffusion layer may comprise a plurality of gas diffusion sub-layers, each sub layer having a different property.

The microporous layer may comprise a plurality of microporous sub-layers, each sub layer having a different property.

Optionally, different areas of each of the gas diffusion sub-layers have different porosities.

Optionally, different areas of each of the microporous sub-layers have different porosities.

The catalyst layer may comprise graphene.

The membrane electrode assembly may form part of a fuel cell assembly.

According to a further aspect, we provide a method of manufacturing a membrane electrode assembly for a fuel cell comprising a proton exchange membrane, and a catalyst layer, the method comprising:
forming a microporous layer and/or gas diffusion layer, wherein the microporous layer and/or gas diffusion layer is formed from at least two different feedstocks:
a first feedstock comprising particles having a first property; and
a second feedstock comprising particles having a second property different to the first property; and the method further comprising;
forming different areas of the layers from the different feedstocks.

This is advantageous as different areas of the layer(s) can be conveniently formed of the two feedstocks, which can be used to influence the physical structure and composition of the layer, for example.

The first property may comprise a first particle size distribution and the second property may comprise a second particle size distribution different to the first particle size distribution. Thus, the feedstocks may be used to create areas of different porosities by virtue of the particle size of the feedstocks.

The first property may comprise the first feedstock including a hydrophobic agent; and the second property may comprise the second feedstock including a hydrophilic agent. Thus, the wetting characteristics of areas of the layer(s) can be controlled. This may be utilised in combination with the size of pores created in the layer(s).

The first and second properties could comprise different degrees of hydrophobicity/hydrophilicity, different materials, be of different densities, or any other property useful for constructing an advantageous fuel cell layer.

The microporous layer and/or gas diffusion layer may be formed by printing.

The microporous layer and/or gas diffusion layer may be formed such that the different areas have different porosities.

The microporous layer and/or the gas diffusion layer may comprise graphene. The method may comprise forming a gas diffusion layer onto a microporous layer. Optionally, the method includes the step of forming the catalyst layer by printing. The catalyst layer may comprise graphene.

According to a further aspect we provide a membrane electrode assembly or a fuel cell assembly incorporating said membrane electrode assembly formed from at least two different feedstocks as described above.

According to a further aspect of the invention, we provide a method of manufacturing a membrane electrode assembly for a fuel cell comprising: printing a graphene containing catalyst layer onto a proton exchange membrane.
Printing the catalyst layer is advantageous as it provides convenient control of graphene distribution in the catalyst layer.

The method may further comprise forming a first microporous layer onto the catalyst layer. The first microporous layer may be formed by printing. The first microporous layer may comprise graphene.

Optionally, the catalyst layer and/or the first microporous layer is formed from at least two different feedstocks:
a first feedstock comprising particles with a first property; and
a second feedstock comprising particles with a second property different to the first property.

Optionally, the first property comprises a first particle size distribution and the second property comprises a second particle size distribution different to the first particle size distribution.

Different areas of the catalyst layer and/or first microporous layer may have different porosities.

Optionally, the first property comprises the first feedstock including a hydrophobic agent; and the second property comprises the second feedstock including a hydrophilic agent.

The method may further comprise forming a first gas diffusion layer onto the microporous layer.

The first gas diffusion layer may be formed by printing. The first gas diffusion layer may comprise graphene.

The first gas diffusion layer may be formed from at least two different gas diffusion layer feedstocks: a first gas diffusion layer feedstock comprising particles with a first property; and a second gas diffusion layer feedstock comprising particles with a second property, different to the first property.

The first property may comprise a first particle size distribution and the second property may comprise a second particle size distribution different to the first particle size distribution. Optionally, the first property comprises the first feedstock including a hydrophobic agent; and the second property comprises the second feedstock including a hydrophilic agent. This may be in combination with the differences in particle size distribution.

Optionally different areas of the first gas diffusion layer have different porosities.

It will be appreciated that the optional features of one aspect of the invention can be applied to the other aspects.

There now follows, by way of example only, a detailed description of embodiments of the invention with reference to the following figures, in which:

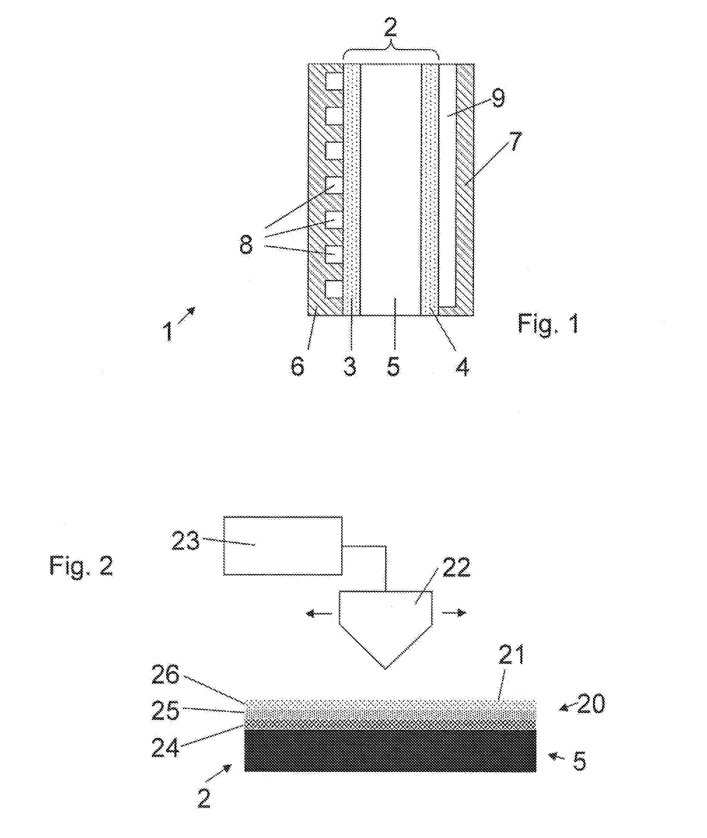

FIG. 1 shows a diagram of a fuel cell assembly;

FIG. 2 shows a diagram of the catalyst layer and its formation;

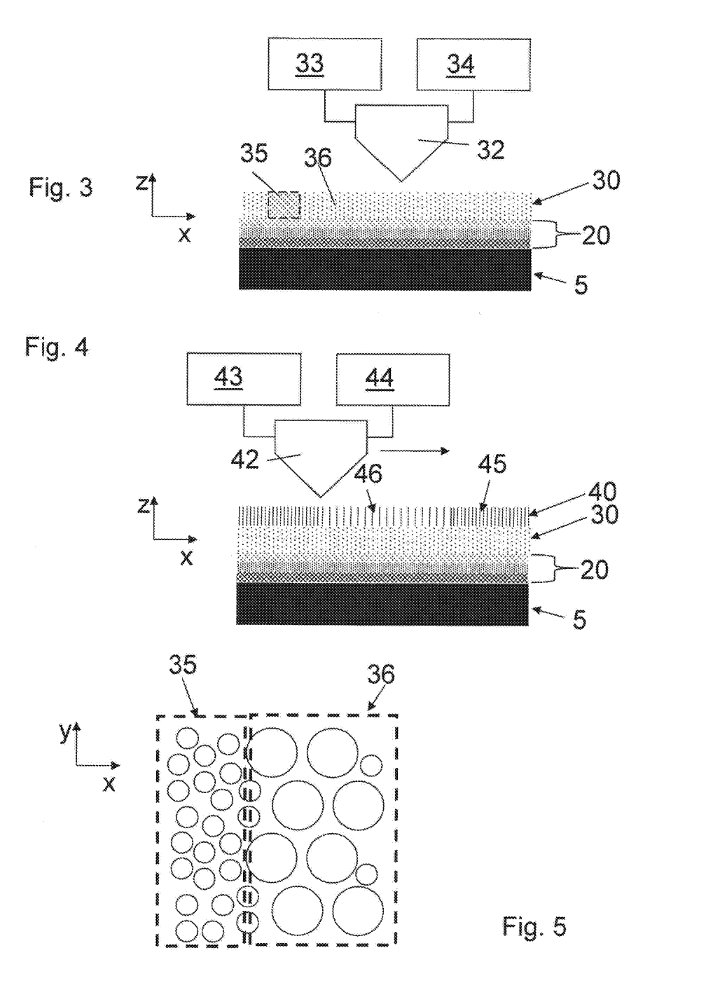

FIG. 3 shows a diagram of the microporous layer and its formation;

FIG. 4 shows a diagram of the gas diffusion layer and its formation;

FIG. 5 shows a diagrammatic plan view of the microporous layer;

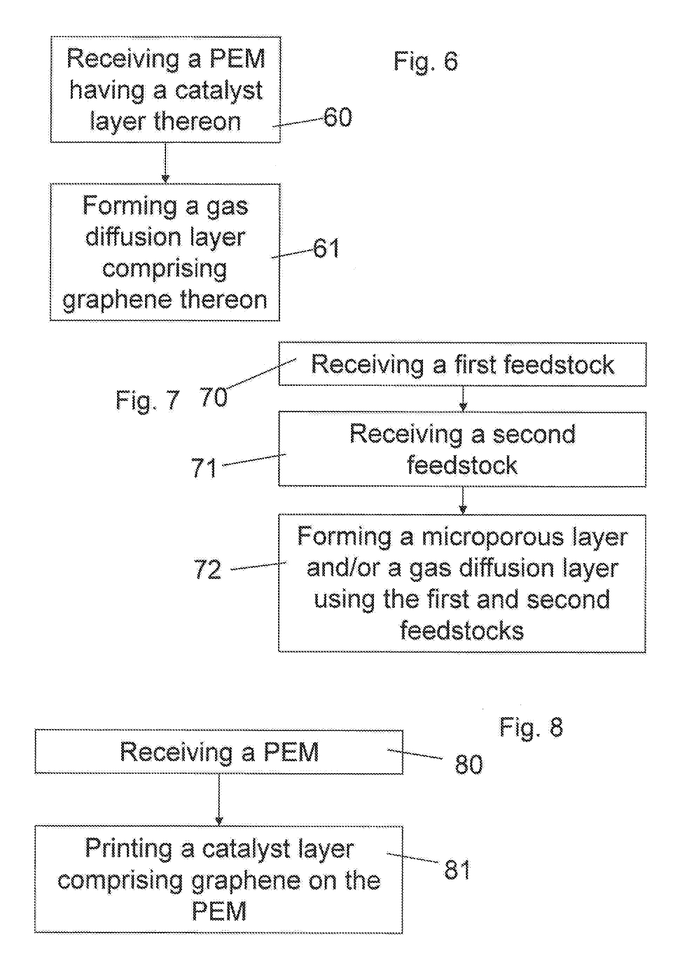

FIG. 6 shows a flow chart illustrating a method of manufacturing a gas diffusion layer;

FIG. 7 shows a flow chart illustrating a method of manufacturing a microporous and/or gas diffusion layer; and

FIG. 8 shows a flow chart illustrating a method of manufacturing a catalyst layer.

The example embodiments describe a fuel cell assembly and, in particular, at least one of a series of layers that form a membrane electrode assembly of the fuel cell assembly. The fuel cell assembly may be a PEM fuel cell, although the fuel cell assembly may be a solid oxide fuel cell or other types.

FIG. 1 shows fuel cell assembly 1 having a membrane electrode assembly (MEA) 2. The MEA 2 includes electrodes comprising an anode 3 and a cathode 4 separated by a proton exchange membrane 5. The electrodes 3, 4 include a plurality of layers as will be described in more detail below. The fuel cell assembly further includes an anode flow plate 6 and a cathode flow plate 7 which include channels 8, 9 for supplying a fuel to the anode 3 and an oxidant to the cathode 4 respectively. The fuel cell 1 may be part of a fuel cell stack comprising a plurality of fuel cells that are stacked and electrically connected together. In a fuel cell stack, the flow plates 6, 7 may be bipolar, in which one side of the plate includes channels for directing fuel to an anode of a particular cell in the stack and the other side includes channels for directing oxidant to a cathode of an adjacent cell in the stack.

FIG. 2 shows the proton exchange membrane 5 and the formation of one side of the MEA 2 thereon. A catalyst layer 20 is shown. The catalyst layer 20 is porous and therefore includes pores 21 to allow the transport of fuel/oxidant and water and other reaction by-products through the catalyst layer 20. The pores have an average size, which may be a diameter or a width, of less than 100 nm. The catalyst layer also includes a catalyst for catalysing a reaction that occurs at the electrode. In a hydrogen-oxygen PEM fuel cell the catalyst at the anode 3 is a substance which catalyses the oxidation of hydrogen. The catalyst in this embodiment is of carbon and, in particular, graphene, which may be in the form of a carbon agglomerate. The catalyst layer is formed by a printer 22, which may be an ink-jet type printer or additive manufacturing also known as a 3D printer. The printer 22 receives a feedstock 23 of carbon agglomerate which it applies to the membrane 5. The printer 22 may incrementally build the catalyst layer 20 with a plurality of passes over the surface, increasing the thickness of the catalyst layer 20 with each pass. Thus, this additive printing method forms the catalyst layer with a plurality of sub-layers. FIG. 2 shows three sub-layers 24, 25 and 26 that form the catalyst layer. The first sub-layer 24 has a small average pore size and a low average density pore distribution. The second sub-layer 25 has a larger pore size and higher pore density distribution and the third sub-layer 26 has an even larger pore size and high density pore distribution.

The use of a printer to form a graphene based catalyst layer 20 in a fuel cell assembly 1 is advantageous. The use of an additive printing technique allows the size of the pores 21 and the distribution of the pores 21 to be controlled for each sub layer. Further, each sub-layer 24, 25, 26 or the catalyst layer 20 as a whole need not be uniform over the entire sub-layer and could have a pore size pattern and/or pore distribution pattern applied over the sub-layers. Thus, different areas of the catalyst layer 22 or sub-layers 24, 25, 26 could have different arrangements of pores, composition or pore size.

The different arrangements of pores, composition or pore size may be achieved by controlling the printer 22 and/or the feedstock 23. In particular, the size of the graphene/carbon particles in the feedstock may be controlled. Further, the feedstock may be of graphene and a filler substance and the ratio of graphene to filler substance in the feedstock may be controlled. The use of a larger particle size feedstock may form a layer or sub-layer having larger pores as the carbon particles may not be able to group together as closely. Likewise, the use of a smaller particle size feedstock may form a layer or sub-layer having smaller pores 21. Thus, for example, a first sub-layer may be formed using a first feedstock and a second sub-layer may be formed using a second feedstock, the first and second feedstocks having different particles sizes. Therefore, a precisely structured graphene catalyst layer 20 can be printed easily. It will be appreciated that the catalyst layer may comprise a single layer rather than being formed of sub-layers.

FIGS. 3 and 4 show the formation of a microporous layer 30 and a gas diffusion layer 40. The microporous layer may or may not be considered to be part of the gas diffusion layer. The microporous layer 30 is located adjacent the catalyst layer 20 and the gas diffusion layer 40 is located adjacent the microporous layer 30 such that the microporous layer 30 is between the catalyst layer 20 and the gas diffusion layer 40. The microporous layer may have a larger average pore size than the catalyst layer 20. In the microporous layer, the pores have an average size, which may be a diameter or a trans-pore width, of less than 400 nm. The pores may be between 50 nm to 400 nm or 100 nm to 400 nm, for example.

With reference to FIG. 3, the microporous layer 30 is of graphene and/or graphene-based nano-pellets and/or carbon powder and/or graphite based materials. The graphene based nano-pellets may be graphene particles of a size between 1 and 100 nm across. The microporous layer 30 may include a hydrophobic agent, such as PTFE, and/or other additives.

In this embodiment the microporous layer is formed by a printer 32. The printer 32 receives two different feedstocks; a first feedstock 33 and a second feedstock 34. The printer may be of ink-jet type or an additive printer. Alternatively, two printers may be provided: one receiving the first feedstock 33 and the other receiving the second feedstock 34. Thus, the two printers work together to form the microporous layer. In the embodiment of FIG. 3, the single printer 32 switches between the feedstocks 33, 34 as required (or uses both at the same time). In other embodiments, the microporous layer may be formed from a single feedstock or a plurality of feedstocks are used such as three, four, five, six or more feedstocks with one or a plurality of printers 32.

The microporous layer 30 in this embodiment has a pattern that extends in-plane (over x and y axis in which the layer lies) rather than through-plane (over z axis). The pattern comprises a first region having different physical properties to a second region. In this embodiment, a higher porosity first region 35 (designated with a dashed box) and a lower porosity second region 36 is provided. Alternatively the first and second regions 35, 36 may have different pore sizes, pore density, hydrophobicity or be of a different material or a combination of structure/properties. The structure/properties of the microporous layer 30 may vary through-plane as well as in-plane.

FIG. 5 shows a plan view of the microporous layer 30 to illustrate the in-plane pore size variation. The region 35 has a larger average pore size than region 36.

The microporous layer 30 including the first and second regions 35, 36 are formed by printing using the two different feedstocks 33 and 34. However, it will be appreciated that other techniques may be used to apply the two different feedstocks 33 and 34 to the catalyst layer 20. The first feedstock 33 comprises graphene nano-particles of a first size. The second feedstock 34 comprises a graphene nano-particles of a second, different size. The printer 32 is configured to use the first feedstock 33 to form the first region 35 and the second feedstock 34 to form the second region 36. Thus, the printer 32 is configured to switch between the feedstocks 33, 34 when a print head 32 passes over the region 35, 36 where an alternate feedstock 33, 34 is required.

The microporous layer 30 may comprise a plurality of sub-layers. The sub-layers may have different or the same properties and may include the same or different in-plane pattern.

The gas diffusion layer 40 is also formed by printing using printer 42, which may be the same printer as used for the microporous layer. The printer 42 receives two different feedstocks; a first feedstock 43 and a second feedstock 44. The printer 42 may be of ink-jet type or an additive printer. Alternatively, two printers may be provided: one receiving the first feedstock 43 and the other receiving the second feedstock 44. Thus, the two printers work together to form the gas diffusion layer. In the embodiment of FIG. 4, the single printer 42 switches between the feedstocks 43, 44 as required (or uses both at the same time). In other embodiments, the gas diffusion layer may be formed from a single feedstock or a plurality of feedstocks may be used, such as three, four, five, six or more feedstocks with one or a plurality of printers 42.

The gas diffusion layer 40 in this embodiment has a pattern that extends in-plane (over x and y axis) such that the layer varies as a function of position transverse to the plane of the layer rather than through-plane (over z axis). The pattern comprises a first region 45 having different physical properties to a second region 46. In this embodiment, the region 45 has a smaller pore size and the second region 46 has a larger pore size. The first and second regions 45, 46 may have different pore sizes, pore density, hydrophobicity or be of a different material or a combination of properties. The properties of the gas diffusion layer 40 may vary through-plane as well as in-plane. Thus, the gas diffusion layer 40 may be formed of sub-layers.

The gas diffusion layer 40 including the first and second regions 45, 46 are formed by printing using the two different feedstocks 43 and 44. It will be appreciated that other techniques may be used to apply the two different feedstocks 43 and 44 to the microporous layer 30. The first feedstock 43 comprises metal power or graphite power having a hydrophobic agent, such as PTFE. The second feedstock 44 comprises a metal powder or graphite powder having a hydrophilic agent, such as PTFE. The printer 42 is controlled such that it forms the smaller pore sized first region 45 and the larger pore sized region 46. Thus, in this embodiment it is control of the printer itself that results in the variation in pore size in the regions 45, 46 rather than resulting from the use of the different feedstocks (although the feedstocks could be used in this way). It will be appreciated that the use of different sized feedstocks in combination with control of the printer is possible. In this embodiment the printer 42 switches between the feedstocks to control the hydrophobicity/hydrophilicity of the gas diffusion layer 40. Accordingly, the first hydrophobic feedstock 43 is used when the printer 42 is set to create the smaller pore first region 45. The second feedstock 44 is used when the printer 42 is set to create the larger pore second region 46. Thus, the printer 42 is configured to switch between the feedstocks 43, 44 at the same time it switches between printing smaller pores 45 and printing larger pores 46.

The MPL 30 and GDL 40 may not be formed by printing and alternative methods may be used to apply the two or more feedstocks to the underlying substrate to form the respective layers. Further, a graphene containing gas diffusion layer 40 may be formed by a different process, such as atomic layer deposition, and may only use a single feedstock. Alternative methods include Chemical Vapour Deposition (CVD) or Graphene spray. The use of a plurality of feedstocks may be used to control porosity of any of the MEA layers or parts of the layers. Alternatively or in addition the use of hydrophobic/hydrophilic feedstocks may be used to control the wetting characteristics of the layers of the MEA or parts of the layers.

It will be appreciated that the structures and methods of manufacture of the various layers can be provided in different combinations or independently of the other layers. For example, one or more of the catalyst layer, microporous layer and gas diffusion layer may comprise graphene. For example, one or more of the catalyst layer, microporous layer and gas diffusion layer may be formed by printing. For example, one or more of the catalyst layer, microporous layer and gas diffusion layer may utilise two or more feedstocks in their formation. For example, one or more of the catalyst layer, microporous layer and gas diffusion layer may include a surface pattern or in-plane structural/composition variations. For example, one or more of the catalyst layer, microporous layer and gas diffusion layer may include sub-layers or through-plane structural/composition variations. The microporous layer may not be present and the catalyst layer 20 may interface directly with the gas diffusion layer 40. Further the membrane electrode assemblies described herein may form part of fuel cell assemblies and the fuel cell assemblies may form part of vehicles or stationary power systems.

FIG. 6 illustrates an example method of forming a gas diffusion layer. The method comprises receiving a proton exchange membrane having a catalyst layer formed thereon at step 60. Step 61 illustrates forming a gas diffusion layer that includes graphene. Step 60 may comprise receiving a proton exchange membrane having a catalyst layer formed thereon as well as a microporous layer. Step 61 may comprise printing the gas diffusion layer.

FIG. 7 illustrates an example method of forming a microporous layer and/or a gas diffusion layer. Step 70 comprises receiving a first feedstock. Step 71 comprises receiving a second feedstock, different to the first feedstock. Step 72 comprises forming a microporous layer and/or a gas diffusion layer using the first and second feedstocks. Step 72 may comprise printing the layers. This method is advantageous as the first and second feedstocks can be used to control the structure or composition of the layers and therefore provide great flexibility when forming the microporous layer and/or a gas diffusion layer. The feedstocks may include graphene.

FIG. 8 illustrates an example method of forming a catalyst layer. The method comprises receiving a proton exchange membrane at step 80. Step 81 illustrates forming a catalyst layer comprising graphene onto the proton exchange membrane. Step 81 may be achieved by printing, such as inkjet printing or additive printing.

The use of graphene in fuel cell components is advantageous. In the microporous layer the use of graphene is advantageous as it is thin and hydrophobic and graphene can be printed with a controlled porosity structure. Similarly, in the gas diffusion layer, graphene can be applied in a controlled manner to achieve a thin, highly conductive layer with a desired porous structure.

1. A method of manufacturing a membrane electrode assembly for a fuel cell comprising a proton exchange membrane and a catalyst layer including a catalyst, the method comprising
forming a gas diffusion layer comprising graphene.

2. The method of claim 1, wherein the forming comprises forming different areas of the gas diffusion layer with different porosities.

3. The method of claim 1, wherein the gas diffusion layer includes a microporous layer, the microporous layer forming an interface between the catalyst layer and the gas diffusion layer.

4. The method of claim 3, wherein one or more of the gas diffusion layer and/or microporous layer is formed by printing.

5. The method of claim 3, wherein only the microporous layer of the gas diffusion layer comprises graphene.

6. (canceled)

7. The method of claim 3, the method further comprising forming the gas diffusion layer and microporous layer from at least two different feedstocks:
wherein a first feedstock comprising particles having a first property; and
wherein a second feedstock comprising particles having a second property different to the first property; and the method comprises; and,
wherein the first property comprises a first particle size distribution and the second property comprises a second particle size distribution different to the first particle size distribution.

8. The method of claim 6, wherein the first property comprises the first feedstock having a hydrophobic agent and the second property comprises the second feedstock having a hydrophilic agent.

9. The method of claim 1, wherein the gas diffusion layer comprises a plurality of gas diffusion sub-layers, each sub layer having a different property.

10. The method of claim 3, wherein the microporous layer comprises a plurality of microporous sub-layers, each sub layer having a different property.

11. The method of claim 9, wherein different areas of each of the gas diffusion sub-layers have different porosities.

12. The method of claim 10, wherein different areas of each of the microporous sub-layers have different porosities.

13-14. (canceled)

15. The method of claim 1, wherein the method includes the step of forming the catalyst layer by printing.

16. The method of claim 1, wherein the catalyst layer comprises graphene.

17. A membrane electrode assembly for a fuel cell comprising:
a proton exchange membrane;
a catalyst layer adjacent the proton exchange membrane; and
a gas diffusion layer comprising graphene.

18. The membrane electrode assembly of claim 17, wherein the gas diffusion layer includes a microporous layer, the microporous layer forming an interface between the catalyst layer and the gas diffusion layer and wherein only the microporous layer of the gas diffusion layer comprises graphene.

19-23. (canceled)

24. The membrane electrode assembly of any one of claim 17, wherein the catalyst layer comprises graphene.

25. A method of manufacturing a membrane electrode assembly for a fuel cell comprising a proton exchange membrane, and a catalyst layer, the method comprising:
forming one or more of a microporous layer and/or gas diffusion layer, wherein the one or more of the microporous layer and gas diffusion layer is formed from at least two different feedstocks:
a first feedstock comprising particles having a first property; and
a second feedstock comprising particles having a second property different to the first property; and the method further comprising;
forming different areas of the layers from the different feedstocks.

26. The method of claim 25, wherein the first property comprises a first particle size distribution and the second property comprises a second particle size distribution different to the first particle size distribution.

27. The method of claim 25, wherein
the first property comprises the first feedstock including a hydrophobic agent; and
the second property comprises the second feedstock including a hydrophilic agent.

28-33. (canceled)

34. A method of manufacturing a membrane electrode assembly for a fuel cell comprising:
printing a graphene containing catalyst layer onto a proton exchange membrane.

35-48. (canceled)
